(19) United States
(12) Patent Application Publication
(10) Pub. No.: US 2015/0297930 A1
(43) Pub. Date: Oct. 22, 2015

(54) TEMPERATURE DERIVATIVE BASED LAUNCH METHOD FOR FIRE SUPPRESSION SYSTEMS

(71) Applicant: MARIOFF CORPORATION OY, Vantaa (FI)

(72) Inventor: Juha-Pekka Nikkarila, Riihimaki (FI)

(73) Assignee: MARIOFF CORPORATION OY, Vantaa (FI)

(21) Appl. No.: 14/441,688

(22) PCT Filed: Nov. 13, 2012
(86) PCT No.: PCT/FI2012/051103

§ 371 Date: May 8, 2015

(51) Int. Cl. A62C 37/40; A62C 35/62; A62C 35/68

(52) U.S. Cl. CPC A62C 37/40; A62C 35/68; A62C 35/62

(57) ABSTRACT

A fire suppression system is provided including at least one spray head. A drive source is coupled to the at least one spray head by a supply line that delivers an extinguishing medium thereto. A control valve is connected to the supply line between the drive source and the at least one spray head. The system includes at least one temperature indicator for measuring a surrounding temperature. A control unit is operably coupled to the drive source, the control valve, and the at least one temperature indicator. The control unit monitors a rate at which the temperature measured by the at least one temperature indicator changes to determine a location of a fire.

### BACKGROUND OF THE INVENTION

The invention relates generally to fire suppression systems and, more particularly, to the detection of the location of a fire by a fire suppression system.

Conventional fire suppression systems typically include sprinklers or nozzles positioned strategically within an area where fire protection is desired, such as inside a building. The sprinklers remain inactive most of the time. In some fire suppression systems, such as dry pipe systems, methods of detecting a fire may be based on the air flow or rate of change in pressure in the system. In other systems, a fire may be detected using flame or smoke detection, or alternatively, the sprinklers may detect a fire and activate as a direct result of the heat.

Fire suppression systems that activate in response to air flow are quick to activate, however, these systems are unreliable and frequently generate false alarms. Fire suppression systems responsive to the rate of change of a pressure within the system are quick to activate, but have problems with measurement reliability due to the high pressure in the system. Conventional fire suppression systems fail to quickly and accurately detect the location of a fire. As a result, systems are over-designed to combat larger fires to compensate for the slowness and inaccuracy of the system. Such over-designing adds significant cost to the system because additional components and more costly components, such as larger diameter pipe for example, are included in the system.

### BRIEF DESCRIPTION OF THE INVENTION

According to one embodiment of the invention, a fire suppression system is provided including at least one spray head. A drive source is coupled to the at least one spray head by a supply line that delivers an extinguishing medium thereto. A control valve is connected to the supply line between the drive source and the at least one spray head. The system includes at least one temperature indicator for measuring a surrounding temperature. A control unit is operably coupled to the drive source, the control valve, and the at least one temperature indicator. The control unit monitors a rate at which the temperature measured by the at least one temperature indicator changes to determine a location of a fire.

According to another embodiment of the invention, a method of detecting and determining a location of a fire with a fire suppression system having a plurality of temperature indicators positioned adjacent a plurality of spray heads is provided including measuring a surrounding temperature at each of the plurality of temperature indicators. A change in temperature over time is calculated for each of the plurality of temperature indicators. The temperature indicators having a change in temperature over time greater than a predetermined threshold are identified.

According to another embodiment of the invention, a method of activating a fire suppression system having a plurality of temperature indicators positioned adjacent a plurality of spray heads and a plurality of fire sensors coupled to the system is provided including detecting a presence of a fire. A drive source and the plurality of temperature indicators are activated. The surrounding temperature at each of the plurality of temperature indicators is measured. A change in temperature over time is calculated for each of the plurality of temperature indicators. The temperature indicators having a change in temperature over time greater than a predetermined threshold are identified. The fire suppression system is activated once temperature indicators having a change in temperature greater than a predetermined threshold are identified.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a fire suppression system according to an embodiment of the invention; and

FIG. 2 is a schematic diagram of another fire suppression system according to an embodiment of the invention.

### DETAILED DESCRIPTION OF THE INVENTION

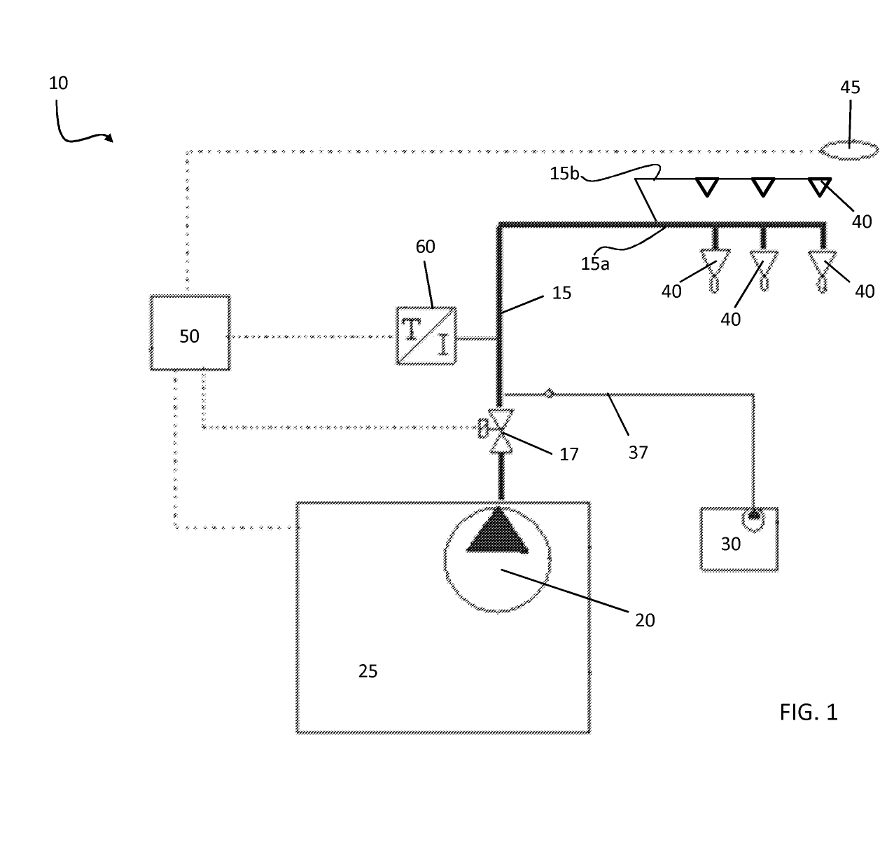

Referring now to FIG. 1, an exemplary fire suppression system 10 including a drive source 20 and a plurality of spray heads 40 is illustrated. In one embodiment, the spray heads 40 include nozzles with small openings arranged to spray an aqueous liquid mist. The spray heads 40 of the fire suppression system 10 may be positioned in the same general area of a building as the drive source 20, or alternatively, may be separated from the drive source 20 by a bather, such as a wall for example. A supply line 15 extends from the drive source 20 to the plurality of spray heads 40 to supply an extinguishing medium thereto. In one embodiment, the extinguishing medium used in the system 10 is water. The drive source 20 may include a pump and a motor for operating the pump and is connected to an extinguishing medium source 25, such as a pipeline network or a tank. A control unit 50 is operably coupled to the drive source 20 to activate the drive source 20 when a fire has been detected.

The supply line 15, including branch supply lines 15a and 15b leading to the spray heads 40, may be filled with a gas, for example an incombustible gas such as nitrogen or air. The gas prevents the supply line 15 and the branch supply lines 15a, 15b from freezing. Instead of filling the entire supply line 15 including the branch supply lines 15a and 15b with gas, it is possible to fill only the portion of the supply line 15 closest to the spray heads 40. In such instances, the end of the supply line 15 adjacent the drive source 20 includes a liquid. The portion of the supply line 15 that includes a gas is separated from the portion of the supply line 15 having a liquid by a control valve 17 to prevent mixing of the gas and the liquid. The control valve 17 may be a solenoid control valve, a pilot valve, or any other type of valve having a control mechanism for opening the valve. The control valve 17 may be located at any position along supply line 15 between the drive source 20 and the spray heads 40. The control valve 17 is operably coupled to the control unit 50, such that when the drive source 20 is active, the control unit 50 opens the control valve 17 to allow extinguishing medium to flow to the spray heads 40.

As illustrated, the system 10 may include a gas compressor 30 connected to the supply line 15 by an output pipe 37. The gas compressor 30 is used to initially fill the supply line 15 and to refill the supply line to a desired pressure when necessary. The gas compressor 30 is also used to maintain a standby pressure in the supply line 15 when the drive source 20 is inoperative. If the standby pressure decreases with time to a level below a predetermined threshold, such as due to leaks in the system 10 for example, the gas compressor 30 increases the pressure by refilling the supply line 15. The fire suppression system 10 may also include one or more fire sensors 45, located in the vicinity of the spray heads 40 to detect a fire condition. Exemplary fire sensors 45 include smoke detectors, temperature sensors, infrared or other light detectors which are used to sense a fire condition and generate an electrical signal indicative thereof. Such signals are transmitted to the control unit 50 to activate the fire suppression system 10. The above described fire suppression system 10 is exemplary and other fire suppression systems are within the scope of this invention.

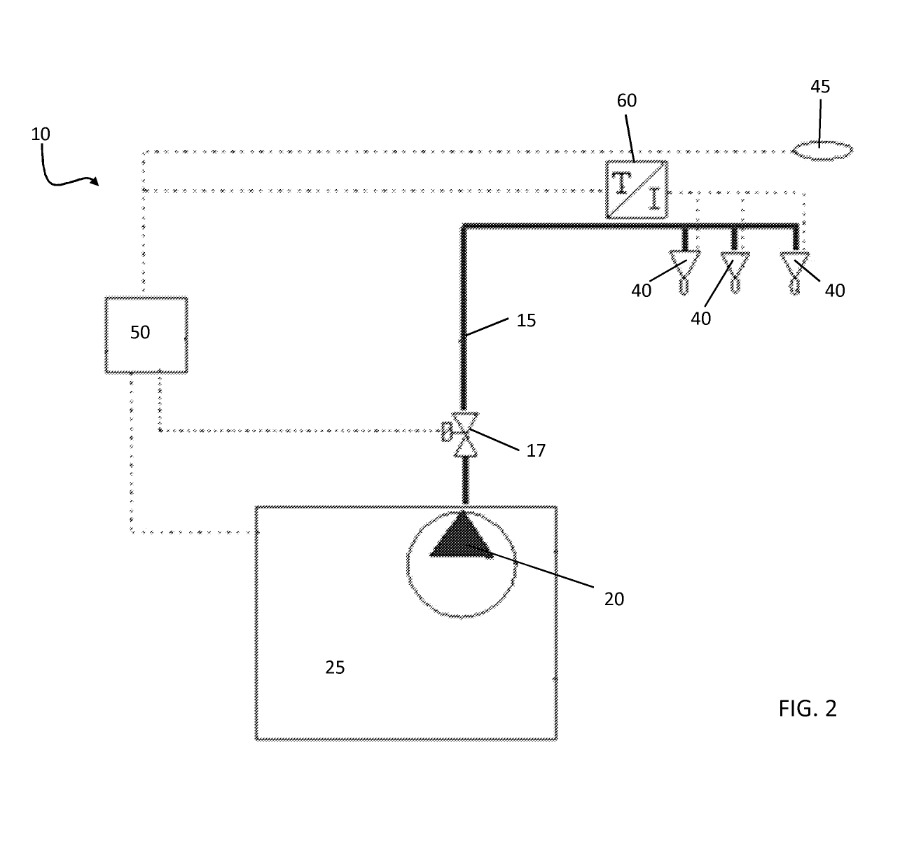

The fire suppression system 10 may also include one or more temperature indicators. Exemplary temperature indicators 60 include thermocouples and other temperature sensors. In dry pipe fire suppression systems, the temperature indicators 60 may be disposed within a portion of the supply line 15 between the control valve 17 and the spray heads 40. In one embodiment, the temperature indicators 60 are positioned in the branch supply lines 15a, 15b adjacent each of the spray heads 40. In another embodiment, illustrated in FIG. 2, the one or more temperature indicators 60 may be used to measure the ambient temperature adjacent the exterior of the spray heads 40. Each temperature indicator 60 may be located in the vicinity of a spray head 40 outside of the supply line 15 or alternately, may be mounted to a portion of each spray head 40. In embodiments where the temperature indicators 60 are located external to the supply line 15, the fire suppression system 10 may be either a dry pipe or a wet pipe system.

The temperature indicators 60 may continuously measure, or alternately, may sample at intervals the surrounding temperature. The temperatures measured by each of the temperature indicators 60 are communicated to the control unit 50, where they are monitored over time to determine the rate of change of the temperature at each device 60. In embodiments where the temperature indicators 60 are located in the supply line 15, a rate of temperature change greater than a predetermined threshold indicates that an adjacent spray head is open. Thus, the temperature indicator 60 measuring the fastest change in temperature over time identifies which spray heads 40 in the system are open, and therefore the general location of a fire. In embodiments where the temperature indicators 60 are attached to or adjacent the exterior of the spray heads 40, a temperature indicator 60 having a rate of change greater than a predetermined threshold indicates the presence of a fire near that temperature indicator 60.

In embodiments where the temperature indicators 60 are disposed within the supply line 15, the rate of temperature change measured at each device 60 may also be used to detect and identify the location of a gas leak. In addition, the fire suppression system 10 can easily identify and generate an alarm to indicate that a temperature indicator 60 has malfunctioned. If the control unit 50 does not receive a signal from a temperature indicator 60 but does receive signals from the surrounding temperature indicators 60, the system 10 can determine that the temperature indicator 60 not providing a signal to the control unit 50 has failed.

When the fire suppression system 10 is in a “detection mode,” the drive source 20 is inactive, but the temperature indicators 60 are actively measuring the surrounding temperature. If the control unit 50 determines that the rate of temperature change at any of the temperature indicators 60 is greater than a predetermined threshold, the control unit 50 will identify those temperature indicators 60 as the location of a fire. The control unit 50 will activate the drive source 20 and open the control valve 17 so that extinguishing medium may be supplied to the open spray heads 40.

In another embodiment, during a normal detection mode, both the drive source and the temperature indicators 60 are inactive; only the fire sensors 45 are operative. When one of the fire sensors 45 detects the presence of a fire, the fire sensor 45 sends a signal to the control unit 50. The fire sensors 45 act as a general alarm, indicating to the fire suppression system 10 a need to determine the location of the fire. In response to the signal from the fire sensor 45, the control unit 50 starts the drive source 20 and activates the temperature indicators 60 connected to the fire suppression system 10. The control unit 50 will monitor the change in temperature over time measured by each temperature indicator 60. If the control unit 50 determines that the rate of temperature change at any of the temperature indicators 60 is above a predetermined threshold, the control unit 50 will identify those temperature indicators 60 as adjacent the general location of a fire. Alternatively, the control unit 50 may identify the temperature indicators 60 having the greatest rate of temperature change as adjacent the general location of the fire. The control unit 50 will activate the drive source 20 and open the control valve 17 so that extinguishing medium may be supplied to the open spray heads 40.

A fire suppression system 10 responsive to a temperature rate of change or temperature derivative will more efficiently and accurately determine the location of a fire. By quickly providing exact information to a building owner about the location of a fire, it may be possible to manually combat the fire at an earlier stage. The system 10 may also be capable of manually or automatically sharing the fire location information with an external group responsive to fire alarms, such as a nearby fire department for example. In addition, the improved fire detection accuracy allows the system to be more appropriately dimensioned for a space, such that additional components, and therefore cost, may be removed from the system 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fire suppression system comprising:
at least one spray head;
a drive source coupled to the at least one spray head by a supply line that delivers an extinguishing medium thereto;
a plurality of temperature indicators for measuring a surrounding temperature; and
a control unit operably coupled to the drive source and the plurality of temperature indicators, wherein the control unit monitors a rate of change of the temperature measured by each of the plurality of temperature indicators to determine a location of a fire.

2. The fire suppression system according to claim 1, wherein the control unit identifies which temperature indicators have a highest rate of temperature change to determine the location of the fire.

3. The fire suppression system according to claim 1, wherein the control unit identifies which temperature indicators have a rate of temperature change above a predetermined threshold to determine the location of the fire.

4. The fire suppression system according to claim 1, wherein the plurality of temperature indicators are disposed within the supply line adjacent the at least one spray head.

5. The fire suppression system according to claim 4, further comprising a control valve connected to the supply line between the drive source and the at least one spray head, wherein a portion of the supply line extending from the control valve to the at least one spray head is filled with a gas.

6. The fire suppression system according to claim 1, wherein the plurality of temperature indicators measure an ambient temperature adjacent the at least one spray head.

7. The fire suppression system according to claim 6, wherein the plurality of temperature indicators are mounted to a portion of the at least one spray head.

8. The fire suppression system according to claim 6, wherein the plurality of temperature indicators are located in a vicinity of the at least one spray head, externally from the supply line.

9. The fire suppression system according to claim 1, further comprising:
a plurality of fire sensors operably coupled to the control unit, wherein activation of one of the plurality of fire sensors provides a general alarm to the fire suppression system.

10. The fire suppression system according to claim 1, wherein the plurality of temperature indicators are thermocouples.

11. A method of activating a fire suppression system having a plurality of temperature indicators positioned adjacent a plurality of spray heads, comprising:
measuring a surrounding temperature at each of the plurality of temperature indicators;
calculating a change in temperature at each of the plurality of temperature indicators over time;
determining a location of a fire based on a rate of temperature change of each of the plurality of temperature indicators; and
activating the fire suppression system.

12. The method according to claim 11, wherein a control unit operably coupled to the plurality of temperature indicators calculates the change in temperature at each of the plurality of temperature indicators over time.

13. The method according to claim 11, wherein the temperature indicators having a rate of temperature change greater than a predetermined threshold indicate the location of the fire.

14. The method according to claim 11, wherein the temperature indicators having a fastest rate of temperature change indicate the location of the fire.

15. A method of detecting and determining a location of a fire using a fire suppression system having a plurality of temperature indicators positioned adjacent a plurality of spray heads and a plurality of fire sensors coupled to the system, comprising:
detecting a presence of a fire;
activating a drive source and the plurality of temperature indicators;
measuring a surrounding temperature at each of the plurality of temperature indicators;
calculating a rate of change in temperature at each of the plurality of temperature indicators;
determining a location of a fire based on a rate of temperature change of each of the plurality of temperature indicators; and
activating the fire suppression system.

16. The method according to claim 15, wherein the plurality of fire sensors detect the presence of a fire.

17. The method according to claim 15, wherein a control unit activates the drive source and the plurality of temperature indicators after receiving a signal from at least one of the plurality of fire sensors.

18. The method according to claim 15, wherein a control unit operably coupled to the plurality of temperature indicators calculates the rate of change in temperature at each of the plurality of temperature indicators.

19. The method according to claim 15, wherein the temperature indicators having a rate of temperature change greater than a predetermined threshold indicate the location of the fire.

20. The method according to claim 15, wherein the temperature indicators having a fastest rate of temperature change indicate the location of the fire.
